(19) United States
(12) Patent Application Publication
(10) Pub. No.: US 2013/0173479 A1
(43) Pub. Date: Jul. 4, 2013

(54) SYSTEM AND METHOD OF DIAGNOSIS OF INCIDENTS AND TECHNICAL SUPPORT REGARDING COMMUNICATION SERVICES

(71) Applicants: Juan A. Paz Salgado, Madrid (ES); José Manuel Montero Duran, Madrid (ES); Jose Maria Rey Poza, Madrid (ES); Mario Lopez Gallego, Madrid (ES)

(72) Inventors: Juan A. Paz Salgado, Madrid (ES); José Manuel Montero Duran, Madrid (ES); Jose Maria Rey Poza, Madrid (ES); Mario Lopez Gallego, Madrid (ES)

(21) Appl. No.: 13/816,363

(22) PCT Filed: Jul. 8, 2011
(86) PCT No.: PCT/EP2011/061574

§ 371 Date: Mar. 13, 2013

(30) Foreign Application Priority Data
Aug. 12, 2010 (ES) P201031250

(51) Int. Cl. G06Q 30/00

(52) U.S. Cl. CPC G06Q 30/016
USPC 705/304

(57) ABSTRACT

System and method of diagnosis of incidents and provision of technical support in a communication service which gathers information both from the user and from previous incidents whose information is stored in a database, and provides an identification of the problem, as well as a solution if possible, by dynamically determining data about the incident and requesting information according to the data.

### FIELD OF THE INVENTION

The present invention has its application within the telecommunications sector and, especially, in the field of incidents management in communication services.

### BACKGROUND OF THE INVENTION

Telecommunication networks, and communication services provided over said networks, are usually expected to be permanently operative. This is the case, for example, of telephone services or internet access, services which are intended to function everyday, at any time.

However, different factors, such as faulty devices, erroneous configurations at any point of the communication network or the user equipment or user's lack of training, may result in the failure of the communication service or in worse performances than expected. For this reason, telecommunication operators usually provide support services that allow users to report incidents in their services, and which try to diagnose and solve said incidents whenever possible (understanding by incident diagnosis the determination of a source, or sources, of a problem perceived by the user).

Different technologies are known to provide support services to customers:
Call centers, in which incidents are reported by telephone to an employee of the telecommunication operator. They are the most common way of providing support to costumers, and usually use IT (Information Technology) tools to improve efficiency. In some cases, different levels of technical expertise are established among the customer support staff. At first, an incoming call is directed to a front line operator with a low technical knowledge. The front line operator follows a predetermined script according to the information provided from the calling user, and if the script is unable to solve the problem, the call is transferred to a second line operator with a higher technical knowledge.
However, call centers require large staffs, especially if the support service is expected to be provided at any time of the day. Also, they are, in a first approach, limited to predefined scripts and to the information provided by the calling user, which results in a low efficiency at solving incidents and diagnosing problems.
Written communications, usually limited to sending users information when a new service is hired, such as Internet Protocol (IP) addresses for Asymmetric Digital Subscriber Lines (ADSL). As this option is not interactive, it is unable to diagnose unexpected incidents in a timely manner.
Interactive Voice Response (IVR) systems, which play pre-recorded messages on the phone, usually to report customers about problems concerning the correct performance of a service. This option also lacks any kind of scripting or artificial intelligence, rendering it unable to diagnose problems.
Web sites, which may include both automatic elements, such as written information or interactive questionnaires, and communication tools to interact with operators, such as chat windows. However, even the interactive elements of web sites follow predetermined processes, thus showing a very low versatility.
Automatic platforms, which provide a software application which is run in the user's terminal (such as a Windows application in a Personal Computer connected to the internet), and which may also communicate with an external server. In addition to the limitations shown by web sites, automatic platforms require software to be run in the user's terminal, which creates installation and maintenance costs as well as security risks.

Among all these technologies, only solutions based on web sites and automatic platforms provide enough interactivity to result in automatic incident diagnosis (that is, without devoting human resources to the task). However, these solutions are based on processes that are only based on the information provided by the user and which follow predefined steps, thus resulting in low adaptability and efficiency.

There is thus the need in the state of the art of a way to provide an efficient and adaptable diagnosis to incidents reported by a user, without requiring human resources.

### SUMMARY OF THE INVENTION

The current invention solves the aforementioned problems by disclosing a system and method that allows to automatically determine the cause of incidents in a communication service, and efficiently restoring said service if possible, by interacting with a user of the service, without the need of establishing a communication with an employee of the communication network's operator, and with an improved efficiency thanks to the use of historical data from the user and reasoning tools which do not follow predefined steps.

In a first aspect of the present invention, a system that provides technical support and diagnoses incidents is disclosed. Incidents are reported to the system by a user of a communication service, and may include any kind of failure or low performance of the network supporting the service or any of its components, as well as a user's perception of a problem when the network is operative. The system comprises:
Communication means adapted to receive from the user information about the incident, and to send to the user diagnosis information (that is, information regarding the source of the incident), and requests for additional information about the incident. The communication means may establish communications via the communication network that supports the service on which the incident is reported, or via any alternative communication network. Communications are performed via a human to machine interface, such as a web interface in a preferred option, although any other interfaces are also valid (for example, a voice-based interface).
A database which provides historic information of the user and incidents reported by him or her. The historic data, which is not considered in traditional customer support systems, complements the information provided by the user, and allows diagnosing the incident more efficiently.
Reasoning means which are adapted to dynamically determine both intermediate data about the incident (that is, facts regarding the status of the network, the user terminal, the user behaviour, etc) and final diagnosis information when enough data are determined. For this purpose, the reasoning means employ the information provided by the user, the historic information retrieved from the database, and data already determined by the reasoning means. Also, reasoning means may use predefined sets of rules, or any other artificial intelligence procedure.

Preferably, the reasoning means also consider information obtained by tests performed by testing means on the communication network, and are also adapted to determine the need to run said test. More preferably, said tests are also performed on a user or network device connected to the communication network.

Also preferably, to further widen the sources employed by the reasoning means, the system comprises a pattern analyzer which reviews historic data so as to detect specific user behaviours which can help in providing him or her with a better technical support.

Preferably, the communication means are also adapted to send configuration commands, which, by being run in the end user devices or in the network nodes providing his or her services, modifies a configuration of said services. This way, the system is not only able to diagnose the cause of an incident, but also to eliminate the problem when it can be solved by a simple reconfiguration.

In a second aspect of the present invention, a method for diagnosis of incidents in a communication service and for providing technical support regarding said service is disclosed. The method starts when a report of a incident is received from a user, and ends when diagnosis information about the incident is provided to the user. In the meantime, the following steps are performed repeatedly (although not necessarily in the following order, as the steps to perform are determined dynamically):
Requesting and receiving information about the incident or technical concern from a user.
Retrieving information about previous incidents and actions from a database.
Determining intermediate data about the incident or concern, and determining final diagnosis information from said intermediate data. The intermediate data is determined from the information provided from the user, the information retrieved from the database, and any previously determined intermediate data.
Preferably, running test on the communication networks and also, more preferably, on the user end devices.
Also preferably, determining information of the about the user's past behaviour by means of a patter analyzer.

According to the data determined about the incident or concern about a given time (that is, all the relevant data known about the network, the service, its elements and behaviour, the user end devices, etc), it is dynamically determined if a diagnosis is obtained, and if not, which steps are to be performed to obtain more information (information requests to the user, database queries, tests and analyses). These decisions may be performed by using a predefined set of rules, or any other artificial intelligence procedure.

As the system and method of the invention dynamically determine which information is required to reach a diagnosis, and to obtain said information, they are not limited to questions to the users, a user is able to receive a diagnosis or solution in an efficient and adaptable manner without the need of a technician. These and other advantages will be apparent in the light of the detailed description of the invention.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a schematic representation of the system of the invention according to one of its preferred embodiments, along with a communication network that supports communication services and an end user device to exemplify the system interactions.

### DETAILED DESCRIPTION OF THE INVENTION

The matters defined in this detailed description are provided to assist in a comprehensive understanding of the invention. Accordingly, those of ordinary skill in the art will recognize that variations, changes and modifications of the embodiments described herein can be made without departing from the scope and spirit of the invention.

Note that in this text, the term “comprises” and its derivations (such as “comprising”, etc.) should not be understood in an excluding sense, that is, these terms should not be interpreted as excluding the possibility that what is described and defined may include further elements, steps, etc.

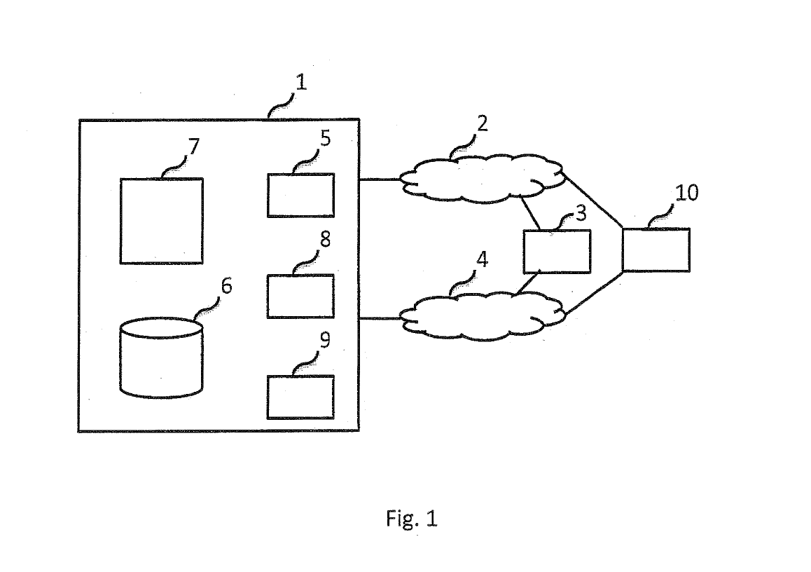

FIG. 1 shows a schematic representation of a system 1 of diagnosis of incidents and provision of technical support in a communication network 2 supporting communication services according to a preferred embodiment of the present invention, which also implements the method of the invention according to a preferred embodiment, as further described in this document. A user terminal 3 is also represented, as well as two different networks: a communication network 2 in which the incident occurs, and an auxiliar network 4 through which the system 1 may communicate with user terminal 3 in case the communication network 2 is no longer operative due to the incident. Note that the user terminal 3 is a device through which a user interacts with the system 1 of diagnosis and technical support, and is not necessarily part of the communication network 2 in which the incident occurs or the technical concern arises. For example, if the incident is detected when using a mobile phone in a telephone network, the user terminal 3 may be that mobile phone if it is the device used to interact with the system 1, but it may also be a computer or any other electronic device used to report the incident to the system through the telephone network, or any other auxiliary network, such as the internet.

Together with the user terminal 3, FIG. 1 also includes an end user device 10, which is again connected to the communication network 2 and may also be connected to the auxiliary network 4 and which supports some communication service being provided to the user but which is not part of network 2. Instead, end user device 10 is an example of the devices that must be placed at the user's home in order for the service to be provided (such as a laptop computer, a remote camera, etc).

The core of the system 1 of diagnosis and technical support are reasoning means 7, which determine the operation of every other element of the system 1. These other elements are communication means 5, which establish the connections with the user; a database 6, which stores historic information about previous incidents reported by the user; testing means 8, pattern analyzer 9.

When an incident is reported by the user, the system guides him or her through an automatic diagnostic and support process that aims to determine the cause of the problem affecting his or her services. In a preferred embodiment, this diagnostic process is directed by the reasoning means 7 by means of a set of rules that are specified by a system administrator. Note that the reasoning means 7 may be implanted within the scope of the present invention with any other kind of artificial intelligence that uses the same sources of information (communications with the user, database, etc).

Rules express the knowledge of the system 1 about the problems that can be diagnosed. Rules can be static (they do not change over time), or they can be dynamically updated by automatically learning from previous iterations of the diagnostic process. An example of a rule structure is:

Fact 1, . . . Fact→Modification 1, . . . , Modification K

This structure means that in order for a rule to be applicable, all the facts in the head must be true. If this happens, the system performs all the indicated modifications to its internal state. At any time, the reasoning means 7 maintain an internal state made up of a number of facts that are valid at that time. Modifications may involve addition of new facts, removal of existing facts or modifications of existing facts. Facts are considered to be any data related to the incident which is not a definitive diagnosis, such as, for example, status information about the communication network 2, the user terminal 3, or the user behaviour.

To gain more information about the incident, from which facts can be determined, the system 1 interacts with the user through the communication means 5. This interaction is typically performed via a web interface but other interfaces are possible, such as voice-based interfaces. Through this interface, the communication means generate interaction units that convey information to the user (such as web pages if a web interface is being used), and that request and collect information from the user.

Another source of information are tests. Tests are automatically performed by the testing means 8 when issued by the reasoning means 7. Tests gather information by interacting with another automatic system, the user end devices 10, or the communication network 2.

The diagnostic process is always executing the following cycle:
See what rules can be fired considering the facts that are true at the moment.
Perform all the actions indicated in the right part of the fired rules. Some of those modifications indicate that interaction units are ready to be conveyed to the user or tests are runnable.
If there are no interaction units or tests to be rendered or run, finish the cycle: No diagnostic has been found.
If there are tests to be run, run all the tests and record their results as facts. Repeat the cycle from the first step (i.e. see what rules can be fired).
If there are no tests to be run but there are interaction units that can be transmitted to the user, select one of the interaction units (and send it to the user).

As part of the artificial intelligence of the reasoning means, it is recommendable that when several possibilities for the incident arise, only one is analyzed at each time. For example, if the effect of modifying a configuration parameter is being analyzed, no further modifications should be performed until the effect of said configuration parameter is stated by the system.

In addition to the described interactions via interaction units and tests, two other sources of information are used by the system when commanded by the reasoning means 7:
Database 6. It stores all internal state of the system. This internal state is used to store historic information regarding any previous interaction between the user and the system. This allows finding behavioural patterns in past sessions. The database 6 also stores all the facts proven to be true for a certain user or incident. These facts may correspond to multiple sessions.
Information about the tests and interaction units may also be stored in the database 6.
Pattern analyzer 9. This module is continuously scanning historic data in order to find patterns that denote some special behaviour of the user (e.g. the ADSL service of the user fails at a much higher rate than usual). Once such a pattern is found, new facts are created to reflect that finding.

In an exemplary embodiment of the invention, the reasoning means 7 are built around a DROOLS rule engine, which implements a version of the RETE algorithm, so as to make deductions based on the available facts. With every iteration, the reasoning means 7 read all the facts which are currently true, feed them into the rule engine and uses that information to select a set of interaction units to be rendered, tests to be run, historic information to be retrieved from the database, and patterns to be analyzed.

Before the next iteration of the cycle, all sets are executed. If there are no tests to be run but there are suitable interaction units to be rendered, all the candidate interaction units are fed into the rule engine again so that the best interaction unit is chosen. This is done by applying a special set of rules which is also configurable. The selected set of tests or the interaction unit is finally sent to the user terminal 3.

The communication means 5 manage the creation, sending and information retrieval of the interaction units. Three types of such units are defined:
Final units: This kind of units conveys information but they are not associated to any test or require any information from the user. They are used to present the final outcome from the diagnostic process.
Asking units: These units prompt the user to enter some information. Whereas final units are always the last one in a session, asking ones are intermediate steps.
Flows: the system is non-deterministic and parallel in nature. That means that all the possible problems are tested at the same time as long as there is enough data to operate on them. Although these features prevent the system from getting stuck if it founds some unexpected circumstance (a reasoning path is aborted but all the others continue to operate), there are times when only a single task must be executed, in order to determine its effect without involving other factors. Every part of the reasoning graph that must be traversed without any side parallelism is called a flow. Flows involve sets of special interaction units.

In a preferred embodiment, once the incident is diagnosed, if the source of the problem can be repaired by the system, it sends configuration commands which perform the required configuration in the user end devices or in network equipments supporting the user's services.

The method and system of the invention are fully configurable, that is, by changing simple rule files or interaction unit definitions, additional scenarios can be devised. They are also accessible by web, so the system can be reached by auxiliar terminals and networks (e.g. if the customer's ADSL is not working, he or she can still reach the system by using his/her mobile phone).

Finally, the rule-based intelligence of the reasoning means, which results in a non-sequential and exhaustive search; and the plurality of information sources; allow to reach diagnostics in an efficient manner, and which is adaptable to any scenario and to any technology of the communication service.

1. A system of diagnosis of incidents and provision of technical support regarding communication services supported on a communication network comprising:
communication apparatus adapted to receive information of incidents and concerns from a user of the communication service and to send diagnosis information and information requests to the user;
a database adapted to store information about previous incidents reported by the user;
reasoning apparatus adapted to:
determine data about the incident from the received information, from the stored information, and from previously determined data;
determine diagnosis information from the determined data;
determine information requests to be sent to the user from the determined data.

2. A system of diagnosis of incidents and provision of technical support according to claim 1, wherein the system further comprises testing apparatus adapted to run tests on the communication network and/or on automatic systems and network devices connected to the communication network and wherein the reasoning apparatus is also adapted to determine tests to be run and to determine data from the run tests.

3. A system of diagnosis of incidents and provision of technical support according to claim 2, wherein the testing apparatus is also adapted to run tests on user end devices.

4. A system of diagnosis of incidents and provision of technical support according to claim 1, wherein the system further comprises a pattern analyzer adapted to determine behavioural patterns within historic data.

5. A system of diagnosis of incidents and provision of technical support according to claim 1, wherein the communication apparatus is adapted to receive the information from the user and to send the diagnosis information and the information requests to the user via a web interface.

6. A system of diagnosis of incidents and provision of technical support according to claim 1, wherein the communication apparatus is also adapted to send configuration commands to modify a configuration of a user end devices and/or in a device of the communication network according to the diagnosis information.

7. A method of diagnosis of incidents and provision of technical support regarding a communication service supported on communication network comprising:
receiving information related to incidents and concerns from a user of the communication network;
retrieving from a database information about previous incidents reported by the user;
determining data about the incident or concern from the received information, from the retrieved information, and from previously determined data;
determining information requests to be sent to the user from the determined data and sending information requests to the user; and
determining diagnosis information from the determined data and sending diagnosis information to the user.

8. A method of diagnosis of incidents and provision of technical support according to claim 7, wherein the method further comprises determining tests to be run from the determined data; running the tests on the communication network, and/or on automatic systems and network devices connected to the communication network and determining data from the run tests.

9. A method of diagnosis of incidents and provision of technical support according to claim 8, wherein the method further comprises running tests on user end devices.

10. A method of diagnosis of incidents and provision of technical support according to claim 7, wherein the method further comprises determining user behavioural patterns by means of a pattern analyzer.

11. A method of diagnosis of incidents and provision of technical support according to claim 7, wherein the steps of receiving the information from the user and sending the diagnosis information and the information requests to the user are performed by a web interface.

12. A method of diagnosis of incidents and provision of technical support according to claim 7, wherein the method further comprises sending configuration commands to modify a configuration of a user end device and/or a device of the communication network according to the diagnosis information.
